(19) United States
(12) Patent Application Publication
(10) Pub. No.: US 2026/0238428 A1
(43) Pub. Date: Aug. 13, 2026

(54) USER EQUIPMENT CAPABILITY INFORMATION RELATED TO RADIO FREQUENCY RETUNING TIME

(71) Applicant: Telefonaktiebolaget LM Ericsson (publ), Stockholm (SE)

(72) Inventors: Zhilan XIONG, SOLNA (SE); Deep SHRESTHA, LINKÖPING (SE); Chunhui ZHANG, STOCKHOLM (SE); Florent MUNIER, FRÖLUNDA (SE)

(73) Assignee: Telefonaktiebolaget LM Ericsson (publ), Stockholm (SE)

(21) Appl. No.: 19/472,815

(22) PCT Filed: Mar. 20, 2024
(86) PCT No.: PCT/SE2024/050253

§ 371 Date: Oct. 6, 2025

Related U.S. Application Data
(60) Provisional application No. 63/456,919, filed on Apr. 4, 2023.

(51) Int. Cl. H04L 5/00; H04W 24/10; H04W 64/00

(52) U.S. Cl. CPC H04L 5/0048; H04W 24/10; H04W 64/00

(57) ABSTRACT

The present disclosure is related to methods, systems, and apparatuses for assistance of RF retuning of a User Equipment, UE. The UE signals towards a network node capability information. The capability information indicates a radio frequency, RF, retuning time of the UE. Further, the UE performs RF retuning. The RF retuning may be for measurement of a downlink reference signal and/or for transmission of an uplink reference signal. The RF retuning is performed in accordance with the indicated capability.

### TECHNICAL FIELD

The present disclosure is related to the field of telecommunication, and, in particular, to user equipments, network nodes, and methods for Radio Frequency (RF) retuning.

### BACKGROUND

The third generation partnership project (3GPP) has discussed new radio (NR) positioning for Rel-18, for example, with potential enhancements for reduced capability (redcap) positioning in which a maximum bandwidth of redcap user equipment (UE) is 20 MHz in frequency range 1 (FR1) and 100 MHz in frequency range 2 (FR2). Agreed enhancements include sounding reference signal (SRS) frequency hopping for positioning accuracy improvement of uplink (UL)-related redcap positioning and positioning reference signal (PRS) frequency hopping for positioning accuracy improvement of downlink (DL)-related redcap positioning.

In a RAN1 #112 meeting, for example, the following was agreed:

### Agreement

For positioning enhancements for redcap UEs for UL SRS transmission (Tx) and DL PRS receive (Rx) frequency hopping, from the RAN1 perspective, short switching time to allow RF retuning between adjacent hops may be beneficial in terms of accuracy and latency performance.
   Send an LS to RAN4 requesting feedback on the feasible values for the switching time between hops, at least when numerology and bandwidth for each hops can be the same, and the Tx/Rx antennas used in all hops can be the same.

There currently exist certain challenge(s). Values may be specified in 3GPP, for example, that define requirements for UEs for RF retuning times, such as for redcap UEs. For example, one redcap UE may be able to do whole intra-slot frequency hopping in FR1 with an SRS of 15 kHz (e.g., one symbol as a RF retuning time between two adjacent hops and one symbol per hop to support six hops), while the UE is not able to do so in other cases.

For example, specified values (e.g., RAN4 specified values) for RF retuning time between adjacent hops may include the values shown in Tables 1 and 2 below:

TABLE 1
RF retuning for UL SRS hopping and DL PRS hopping for FR1

| | UL SRS | | | DL PRS |
|---|---|---|---|---|
| SCS | 15 kHz and | 60 | kHz | Any |
| | 30 kHz | | | |
| Same UL power for different SRS | ~50 us | ~50 | us | ~50 us |
| transmission (e.g., intra-slot | | | | |
| hopping) | | | | |

| | | |
|---|---|---|
| Different UL power for different | ~60 us | ~50 us + one |
| SRS transmission, (e.g., inter-slot | | blanked symbol |
| hopping) | | (17.84 us) = ~67.84 Us |

TABLE 2
RF retuning for UL SRS hopping and DL PRS hopping for FR2

| | UL SRS | | | | DL PRS |
|---|---|---|---|---|---|
| SCS | 60 | kHz | 120 | kHz | Any |
| Same UL power for different SRS | ~100 | us | ~100 | us | ~100 us |
| transmission (e.g., intra-slot | | | | | |
| hopping) | | | | | |

| | | | |
|---|---|---|---|
| Different UL power for different | ~105 | us | ~100 us + one blanked |
| SRS transmission, (e.g., inter-slot | | | symbol = ~108.93 us |
| hopping) | | | |

However, the RF retuning time of some UEs (e.g., redcap UEs) may be 0 μs or 30 μs, for example, which is better than the specified values (e.g., the example specified values in Tables 1 and 2 herein).

FIG. 1 is a schematic drawing of an example of partially overlapped frequency hopping for a reference signal.

As the frequency hopping for reference signal measurements (e.g., SRS and/or PRS measurement) is new, defined rules are lacking regarding in which symbol a UE performs RF retuning.

When a UE is configured with PRS measurement, for example, with a frequency hopping set, it is expected that the UE can derive a wideband channel estimation with the received PRS measurement in different frequency locations. To do so, the UE needs to re-tune its phase-locked loop (PLL) to a new frequency location if this frequency hop is not the last frequency hop in a frequency hop set. Such RF retuning may take place in a special symbol position in order to make efficient use of the network resource and, optionally, to gain power savings.

In a scenario where different RF tuning times are reported by the UE, the network node may need to accommodate these UEs with, preferably, the same PRS configuration.

### SUMMARY

Certain aspects of the disclosure and their embodiments may provide solutions to these or other challenges.

Some embodiments are directed to a method performed by a User Equipment, UE. The method includes signaling, towards a network node, capability information. The capability information indicates a Radio Frequency, RF, retuning time of the UE. The method further comprises performing RF retuning. The RF retuning being performed for measurement of a downlink reference signal and/or transmission of an uplink reference signal. The RF retuning being performed in accordance with the indicated capability.

Some embodiments are directed to a User Equipment, UE. The UE is configured to signal, towards a network node, capability information. The capability information indicates a radio frequency, RF, retuning time of the UE. The UE is further configured to perform RF retuning. The RF retuning being performed for measurement of a downlink reference signal and/or transmission of an uplink reference signal. The RF retuning being performed in accordance with the indicated capability.

Some embodiments are directed to a method performed by a network node. The method includes receiving, from a user equipment, UE, capability information. The capability information indicates a radio frequency, RF, retuning time of the UE. The method further comprises signaling, to the UE, a configuration. The configuration being a configuration of at least one of a downlink reference signal and an uplink reference signal. The configuration comprises a frequency hopping configuration of the downlink reference signal and/or the uplink reference signal.

Some embodiments are directed to a network node. The network node is configured to receive, from a user equipment, UE, capability information. The capability information indicates a radio frequency, RF, retuning time of the UE. The network node is further configured to signal, to the UE, a configuration. The configuration being a configuration of at least one of a downlink reference signal and an uplink reference signal. The configuration comprises a frequency hopping configuration of the downlink reference signal and/or the uplink reference signal.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is a schematic drawing of an example of partially overlapped frequency hopping for a reference signal;

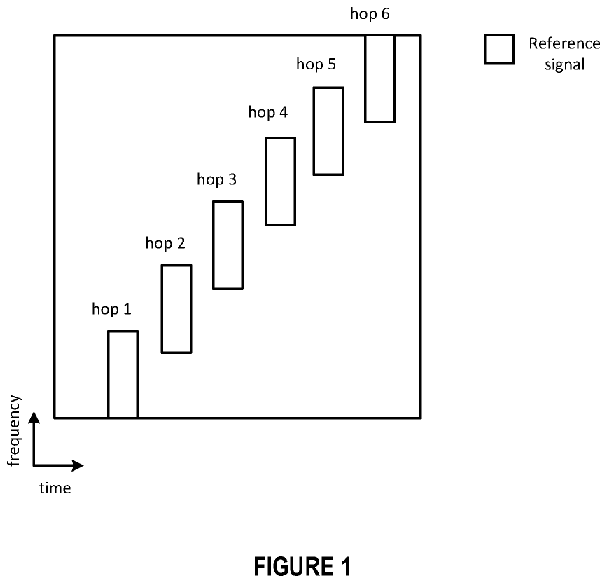

FIG. 2 is a schematic diagram of an example of symbols in a slot before a first configured orthogonal frequency division multiplexing (OFDM) symbol of a PRS resource or the OFDM symbols after a last configured OFDM symbol of the PRS resource in accordance with some embodiments;

FIG. 3 is a schematic diagram of an example of a sequential hopping pattern for intra-slot hopping for PRS reception in accordance with some embodiments;

FIG. 4 is a schematic diagram of an example of a sequential hopping pattern for intra-slot hopping for PRS reception in accordance with some embodiments;

FIGS. 5-8 are flowcharts illustrating example operations of a UE in accordance with some embodiments;

FIGS. 9-12 are flowcharts illustrating example operations of a network node in accordance with some embodiments;

FIG. 13 is a block diagram of a communication system in accordance with some embodiments;

FIG. 14 is a block diagram of a UE in accordance with some embodiments;

FIG. 15 is a block diagram of a network node in accordance with some embodiments;

FIG. 16 is a block diagram of a host computer communicating with a UE in accordance with some embodiments;

FIG. 17 is a block diagram of a virtualization environment in accordance with some embodiments; and

FIG. 18 is a block diagram of a host computer communicating via a base station with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

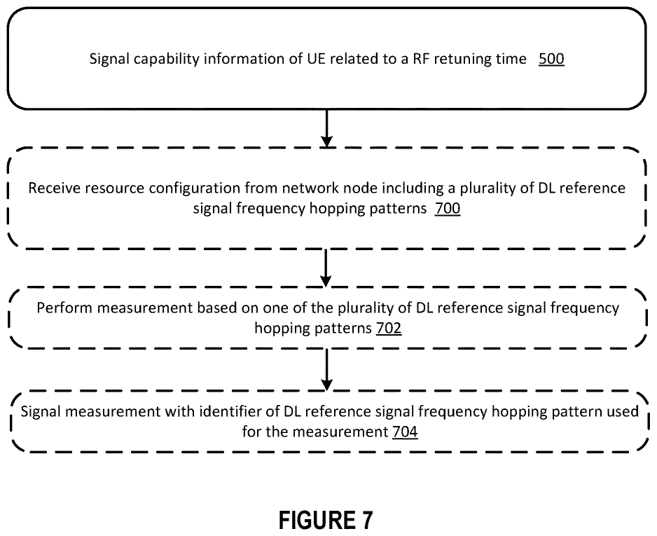

Certain aspects of the disclosure and their embodiments may provide solutions to these or other challenges. Some embodiments are directed to a method performed by a UE. As illustrated in FIG. 5, a method performed by a UE is provided. The method includes signaling (500), towards a network node, a capability information of the UE related to a RF retuning time. In an example, the UE reports the capability information that includes the UE's minimum RF retuning time between two adjacent frequency hops for PRS reception and/or SRS transmission as well as a related procedure and configuration between a network node and the UE and inside a network. Further, in some embodiments, the method further includes performing (502) the RF retuning based on the capability indication.

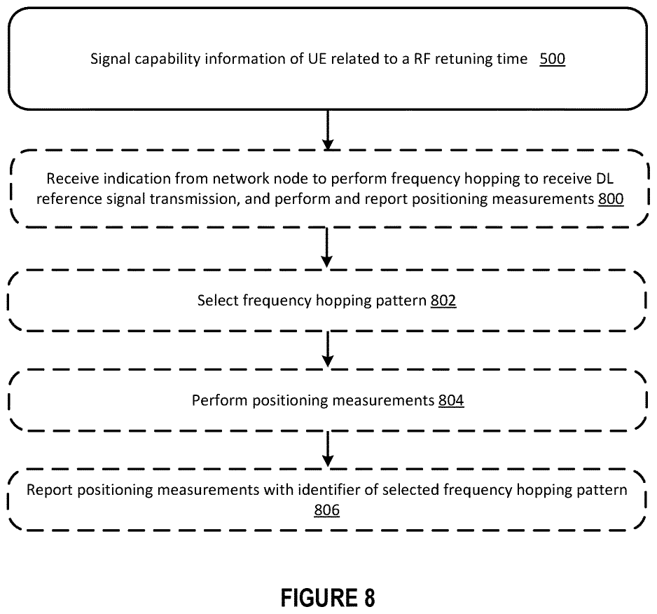

Some other embodiments are directed to a method performed by a network node. As illustrated in FIG. 9, a method performed by a network node is provided. The method includes receiving (900) a capability information of a UE related to a RF retuning time. In an example, a network node uses a pre-configured UE RF retuning time between two adjacent frequency hops for PRS reception and/or SRS transmission for the configurations of DL PRS resources and/or UL SRS resources.

The RF retuning time can include a RF retuning time between two adjacent frequency hops for at least one of a DL reference signal and an UL reference signal. The DL reference signal can include a DL PRS and the UL reference signal can include a SRS.

Examples of the present disclosure include rules regarding in which symbol a UE performs RF retuning. In some embodiments, the UE performs the RF retuning based on at least one of the following (i) an RF retuning time for at least one of a downlink reference signal reception hop and an uplink reference signal transmission hop from a center frequency to a new center frequency, (ii) a configured downlink reference signal density, (iii) an offset to orthogonal frequency division multiplexing (OFDM) symbols of a downlink reference signal resource, and (iv) a RF retuning time gap configured by the network node. For example, rules are provided where a UE performs RF retuning based on the following factors:
1. UE reported capability on the RF retuning time for a PRS hop and SRS transmission hop from one center frequency to a new center frequency,
2. The configured PRS density, e.g., the comb factor,
3. The offset to the OFDM symbols of a PRS resource, and/or
4. Whether or not the network will configure a RF retuning time gap.

A UE can report its capability about a minimum RF retuning time between two adjacent frequency hops for at least one of PRS reception frequency hopping and SRS transmission frequency hopping, and this report may be due to the request from the network. A corresponding network node for this information exchange can be a location server. In another example, the corresponding network node for this information exchange can be a base station.

In some embodiments, the capability information is used for at least one of (i) a time-frequency resource configuration for a DL reference signal transmission from the network node to the UE and (ii) a time-frequency resource configuration for an UL reference signal transmission from the UE to the network node. For example, the network node can use the capability information for time-frequency resource configuration for DL PRS transmission from the network to the UE, and/or use the capability information for time-frequency resource configuration for UL SRS transmission from the UE to the network.

In the network, the location server can send the received capability information to the base station.

In the network, the base station can use the received capability information for the time-frequency resource configuration.

In the reported capability information from the UE to the network node, the value of the RF retuning time (e.g., minimum RF retuning time) can be 0 μs, 30 μs, 50 μs, 60 μs, 100 μs, 110 μs, or 120 μs.

In some examples, the capability information is pre-configured at the network node. In some embodiments, the network node uses the capability information for a time-frequency resource configuration for DL reference signal transmission to the UE, and/or the capability information is used for a time-frequency resource configuration for an UL reference signal transmission from the UE to the network node.

For example, the network node can use the pre-configured UE RF retuning time between two adjacent frequency hops for time-frequency resource configuration for DL reference signal transmission from the network node to the UE, and/or uses the capability information above for time-frequency resource configuration for UL reference signal transmission from the UE to the network node. It is noted that as referred to her a pre-configured UE RF retuning time refers to the UE RF retuning time pre-configured at the network side for this feature target to the UE(s) (e.g., to redcap UEs). For example, a pre-configured UE RF retuning time between two adjacent frequency hops can be the pre-configured redcap UE RF retuning time between two adjacent frequency hops.

In some embodiments, the method performed by a UE further includes receiving (operation 600 in FIG. 6) a DL reference signal resource configuration from the network node for DL reference signal measurement including at least one of wideband DL reference signal frequency hopping and narrowband DL reference signal frequency hopping; and performing (operation 602 in FIG. 6) at least one of a measurement based on (i) partial DL reference signal hops based on the RF retuning capability of the UE and (ii) all DL reference signal hops based on the RF retuning capability of the UE.

For example, the network node can configure PRS resource information to the UE for PRS measurement and the UE may measure partial PRS hops based on its RF retuning capability, where the PRS resource information may be wideband PRS or may be narrowband PRS frequency hopping.

In some embodiments, the method performed by a UE further includes receiving (operation 700 in FIG. 7) a resource configuration from the network node comprising a plurality of DL reference signal frequency hopping patterns; performing (operation 702 in FIG. 7) a measurement based on one of the plurality of DL reference signal frequency hopping patterns; and signaling (operation 704 in FIG. 7), towards the network node, the measurement with an identifier of the one DL reference signal frequency hopping pattern used for the measurement.

For example, the network node can configure multiple PRS frequency hopping patterns to the UE and the UE can report the corresponding measurement results to the network node with an identified (ID) of the PRS frequency hopping pattern used for corresponding measurement results.

Certain embodiments may provide one or more of the following technical advantage(s). Based on the inclusion of the capability information of a UE related to a RF retuning time, a resource configuration may be optimized (e.g., for a reference signal, such as a PRS and/or SRS). A further technical advantage based on the inclusion of the capability information may include that UE behavior on a symbol location of RF retuning is defined so the network can configure a frequency hop in a more resource efficient and power efficient manner.

In one example, the network node can configure a time gap for RF retuning based on the maximum reported RF tuning time. In this way, all the UEs performing a PRS measurement can use the network configured parameter. In the absence of such configuration from network, a UE may use a default time gap for its RF tuning from one hop to another hop.

In some embodiments, for example, the RF retuning time gap is based on a maximum reported RF tuning time from one or more UEs.

In another example, the UE can be configured with which symbol position to use for the RF retuning based on one PRS configuration. For example, in an intra-slot frequency hopping, the UE may be indicated to use one PRS symbol after the first PRS symbol received in a frequency hop. Such indication may depend on the PRS density configured, for example, the UE may deem one PRS symbol reception is good enough when PRS density is high (e.g., PRS comb size is low). A non-limiting example of such an indication is illustrated in Table 3 below:

TABLE 3
RF retuning symbol location in relation to comb size

| | | | # of symbol |
|---|---|---|---|
| | # of PRS symbols | Symbol | to be used |
| PRS | to be received | position for | for RF |
| comb size | for one hop | RF retuning | retuning |
| 2 | 1 | 2nd of PRS symbol | 1 or 2 |
| 4 | 2 | 3rd of PRS symbol | 1 or 2 |

In some embodiments, for example, the UE uses a symbol location for the RF retuning based on a DL reference signal configuration.

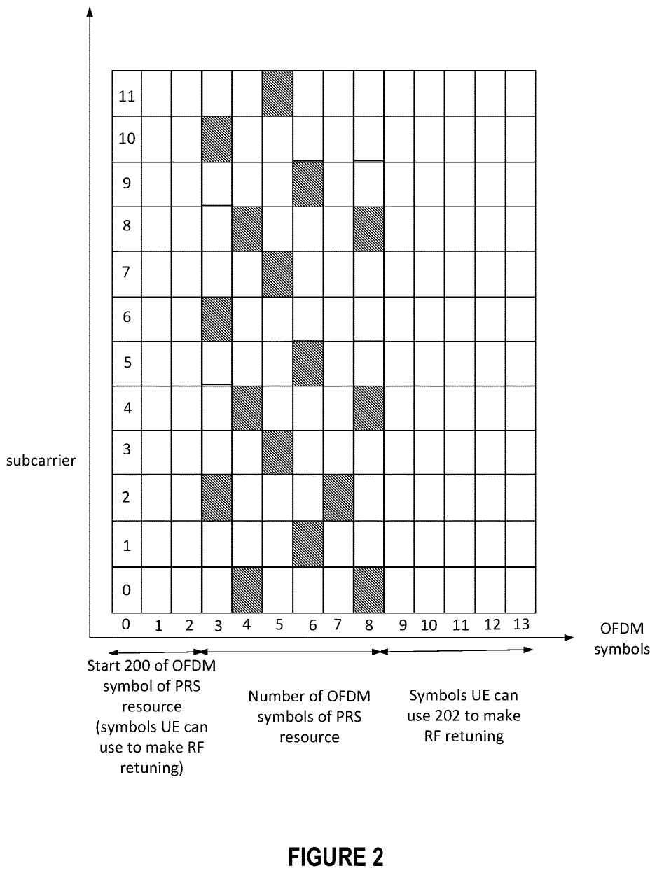

In another example, as illustrated in FIG. 2, for inter-slot frequency hopping of PRS measurements, the RF retuning can happen at the beginning 200 of the symbols in a slot before the first configured OFDM symbol of the PRS resource or the OFDM symbols 202 after the last configured OFDM symbol of the PRS resource. The first three symbols in the example of FIG. 2 can be used by the UE to perform the RF retuning. The network node can indicate to the UE where the RF retuning is to take place, either at the beginning of the OFDM symbols in a slot or the end of the OFDM symbols in a time slot. The network node may expect the UE to monitor the last OFDM symbols in a slot in the first time slot and, thus, expect the UE to perform the RF retuning at the beginning of the symbols of next hop. The network node also may expect the UE to perform the RF retuning at the end of symbols of a last hop so when UE finishes frequency hops, there is no interruption expected after the UE hops back to the original frequency.

In some embodiments, for example, the offset to OFDM symbols of the DL reference signal resource includes at least one of (i) symbols of a first slot before a first configured OFDM symbol of the DL reference signal resource, and (ii) OFDM symbols after a last configured OFDM symbol of the DL reference signal resource.

In another example, a UE sends its capability information related to a minimum time for RF retuning between two adjacent frequency hops for PRS reception to a location server. This report may be due to a request from the location server, for example, a request for DL-time difference of arrival (TDOA) capability or a request for multiple round trip time (multi-RTT) capability. After receiving this information from the UE, the location server can send this information to a base station and the base station can use this information for its PRS transmission.

For example, in some embodiments, the network node includes a location server. The RF retuning time can include a RF retuning time between two adjacent frequency hops for DL reference signal reception, and signaling the capability information is responsive to a request from the location server. Further, in some embodiments, the location server sends the capability information to a base station to use for a DL reference signal transmission.

In yet another embodiment, a UE sends its capability information related to a minimum time for RF retuning between two adjacent frequency hops for UL reference signal transmission to the location server. This report may be due to a request from the location server, for example, a request for UL-TDOA capability or a request for multi-RTT capability. After receiving this information from the UE, the location server may send this information to a base station. The base station may use this information to configure UL SRS resources, for example, in a time and frequency domain for the UE.

In some embodiments, for example, the network node includes a location server. The RF retuning time includes a RF retuning time between two adjacent frequency hops is for UL reference signal transmission, and signaling the capability information is responsive to a request from the location server. In some embodiments, the location server sends the capability information to a base station to configure UL reference signal resources in time and frequency domain for the UE.

In another example, a UE sends its capability related to a minimum time for RF retuning between two adjacent frequency hops for PRS reception to the base station. This report may be due to the request from the base station. The base station may use this information to configure DL PRS resources in a time and frequency domain for PRS transmission, for example, to the UE.

For example, in some embodiments, the network node includes a base station. The RF retuning time includes a RF retuning time between two adjacent frequency hops for DL reference signal reception to the base station, and the signaling the capability information is responsive to a request from the base station. In some embodiments, the base station uses the capability information to configure DL reference signal resources in time and frequency domain for a DL reference signal transmission from the base station.

In a further example, a UE sends its capability related to a minimum time for RF retuning between two adjacent frequency hops for SRS transmission to the base station. This report may be due to a request from the base station. The base station may use this information to configure UL SRS resources in a time and frequency domain for the UE.

In some embodiments, for example, the network node includes a base station. The RF retuning time includes a RF retuning time between two adjacent frequency hops for UL reference signal transmission to the base station, and the signaling the capability information is responsive to a request from the base station. In some embodiments, the base station uses the capability information to configure UL reference signal resources in time and frequency domain for the UE.

In another example, the network node (e.g., base station) can use specified UE requirements (e.g., specified in 3GPP) as an assumption of the time for RF retuning between two adjacent frequency hops for PRS reception at the UE side when configuring the time-frequency resources for DL PRS transmission.

In some embodiments, the network node uses the capability information to set the RF retuning time between two adjacent frequency hops for DL reference signal reception at the UE side when configuring a time-frequency resource for a DL reference signal transmission.

In another example, the network node (e.g., base station) can use specified UE requirements (e.g., specified in 3GPP) as an assumption of the time for RF retuning between two adjacent frequency hops for SRS transmission at the UE side when configuring the time-frequency resources for UL SRS transmission.

In some embodiments, the network node uses the capability information to set the RF retuning time between two adjacent frequency hops for UL reference signal transmission at the UE side when configuring a time-frequency resource for an UL reference signal transmission.

Non-limiting examples of an indicated value in the capability indication of RF retuning time include at least one of 0 μs, 30 μs, 50 μs, 60 μs, 100 μs, and 120 μs. For example, in some embodiments, the RF retuning time includes a value of a minimum RF retuning time including at least one of 0 μs, 30 μs, 50 μs, 60 μs, 100 μs, 110 μs, and 120 μs.

In some embodiments, the network node configures a frequency hopping pattern to the UE based on the capability information for at least one of intra-slot frequency hopping and inter-slot frequency hopping.

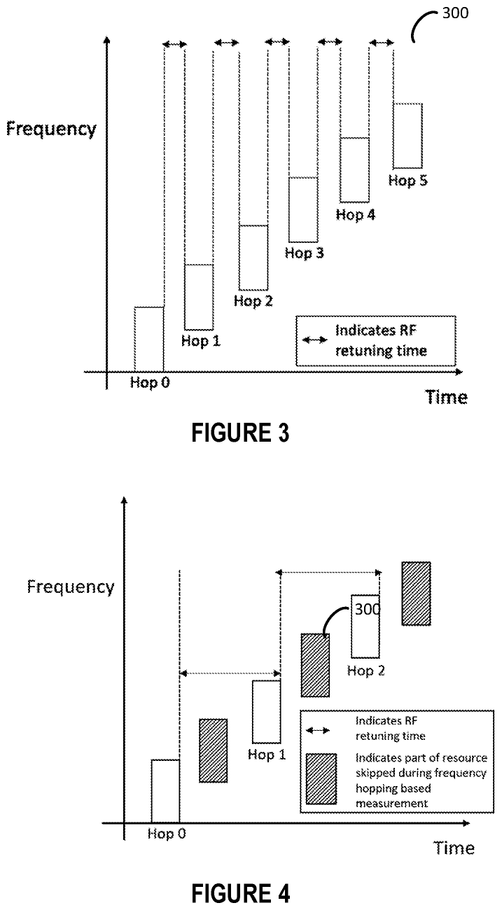

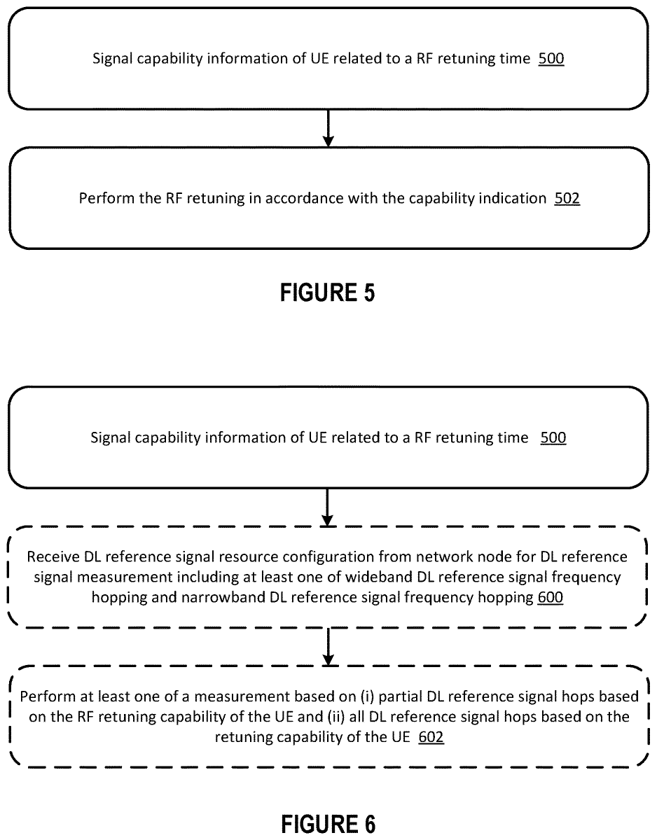

In an example, depending on the UE reported RF tuning capability information, the network configures a frequency hopping pattern to the UE. In the example of FIGS. 3 and 4, a network configured sequential hopping pattern for intra-slot frequency hopping for PRS reception is shown. FIG. 3 shows an example of a hopping pattern configured to a UE that supports a shorter RF tuning time 300 between two adjacent frequency hops, as illustrated. FIG. 4 shows an example of hopping patterns configured to a UE that supports a relatively longer RF tuning time 300, as illustrated. In FIG. 4, the indicated RF retuning time 300 includes a time between hops (e.g., between hop 0 and hop1, and between hop 1 and hop 2, respectively, that includes part of a resource skipped during frequency hopping based on measurement and a reference signal. It is noted that these examples also are suitable for inter-slot frequency hopping.

In some embodiments, the network node configures a plurality of frequency hopping patterns to the UE based on the capability information for at least one of intra-slot frequency hopping and inter-slot frequency hopping.

Referring to FIG. 8, in some embodiments, the method performed by a UE further includes receiving (800) an indication from the network node to perform frequency hopping to receive a DL reference signal transmission, and to perform and to report positioning measurements. The method further includes selecting (802) a frequency hopping pattern; performing (804) the positioning measurements; and reporting (806) the positioning measurements with an identifier of the selected frequency hopping pattern.

For example, multiple frequency hopping patterns can be configured to the UE. When the UE receives an indication from the network node to perform frequency hopping to receive DL PRS and perform and report positioning measurements, the UE can select one of the hopping patterns and indicate the hopping ID when positioning measurements are reported to the network node. It is noted that this example also is suitable for inter-slot frequency hopping.

Referring to FIG. 10, in some embodiments, the method performed by the network node further includes signaling (1000) a DL reference signal resource configuration for DL reference signal measurement including at least one of wideband DL reference signal frequency hopping and narrowband DL reference signal frequency hopping.

Referring to FIG. 11, in some embodiments, the method performed by the network node further includes signalling (1100) a resource configuration to the UE including a plurality of DL reference signal frequency hopping patterns; and receiving (1102) (i) measurements based on one of the plurality DL reference signal frequency hopping patterns and (ii) an identifier of the one DL reference signal frequency hopping pattern used for the measurement.

Referring to FIG. 12, in some embodiments, the method performed by the network node further includes signaling (1200) an indication to the UE to perform frequency hopping to receive a DL reference signal transmission, and perform and report positioning measurements; and receiving (1202) a report from the UE including the positioning measurements with an identifier of the selected frequency hopping pattern.

In some embodiments, the capability information of the UE related to a RF retuning time includes capability information based on a reduced signaling capability of the UE. In some embodiments, the DL reference signal includes a PRS, and the UL reference signal includes a SRS.

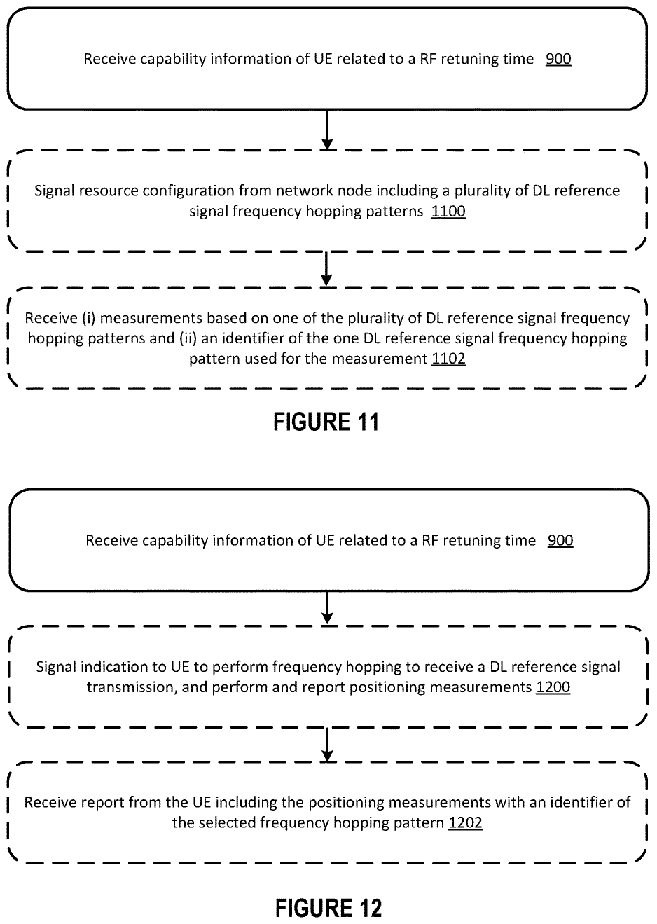

Operations of a UE can be performed by the UE 1400 of FIG. 14. Operations of the UE (implemented using the structure of FIG. 14) have been described with reference to the flow charts of FIGS. 5-8 according to some embodiments of the present disclosure. For example, modules may be stored in memory 1410 of FIG. 14, and these modules may provide instructions so that when the instructions of a module are executed by respective UE processing circuitry 1402, UE 1400 performs respective operations of the flow charts. Operations 502, 600, 602, 700-704, and 800-806 from the flow chart of FIGS. 5-8 may be optional with respect to some embodiments of UEs and related methods.

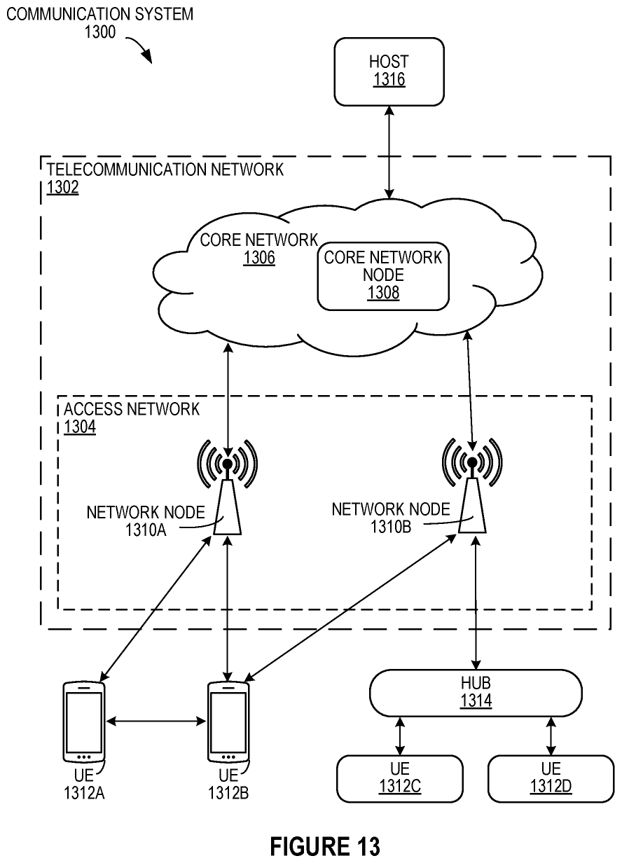

Operations of a network node can be performed by the network node 1500 of FIG. 15. Operations of the network node (implemented using the structure of FIG. 15) have been described with reference to the flow charts of FIGS. 9-12 according to some embodiments of the present disclosure. For example, modules may be stored in memory 1504 of FIG. 15, and these modules may provide instructions so that when the instructions of a module are executed by respective network node processing circuitry 1502, network node 1500 performs respective operations of the flow charts. Operations 1000, 1100-1102, and 1200-1202 from the flow chart of FIGS. 10-12 may be optional with respect to some embodiments of network nodes and related methods,

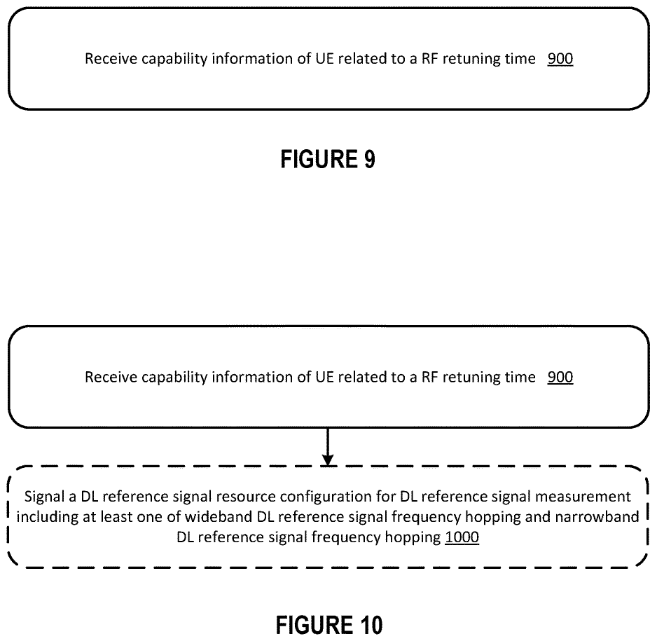

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1302 includes one or more Open-RAN (ORAN) network nodes. An ORAN network node is a node in the telecommunication network 1302 that supports an ORAN specification (e.g., a specification published by the O-RAN Alliance, or any similar organization) and may operate alone or together with other nodes to implement one or more functionalities of any node in the telecommunication network 1302, including one or more network nodes 1310 and/or core network nodes 1308.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

FIG. 14 shows a UE 1400 in accordance with some embodiments. As used herein, a UE refers to a device capable, configured, arranged and/or operable to communicate wirelessly with network nodes and/or other UEs. As previously referenced herein, capability information of a UE related to a RF retuning time includes capability information based on a reduced signaling capability of the UE (e.g., such as for a redcap UE or other UE). Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU), or a location server. As previously discussed herein, a location server can communicate with a base station.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

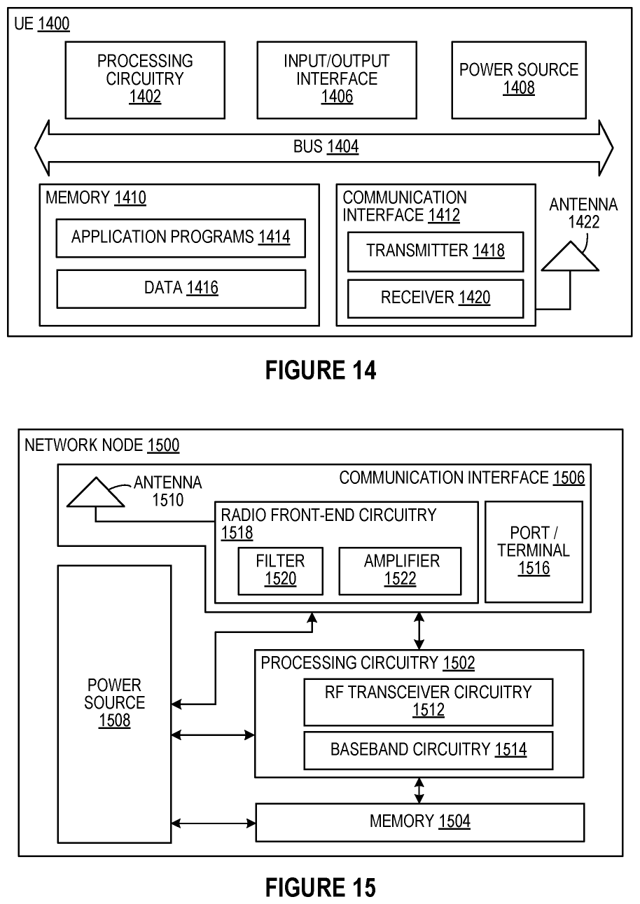

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 15 and 16, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

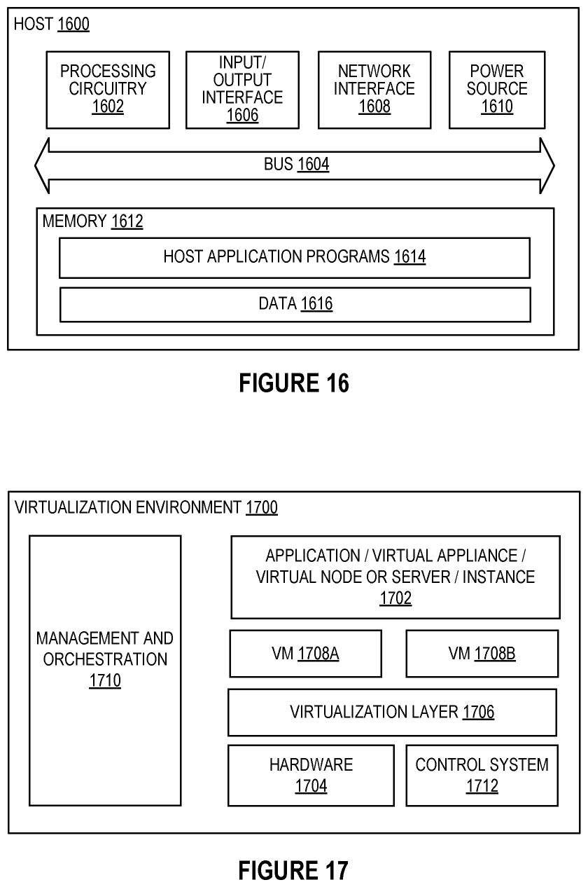

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1700 includes components defined by the O-RAN Alliance, such as an O-Cloud environment orchestrated by a Service Management and Orchestration Framework via an O-2 interface.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

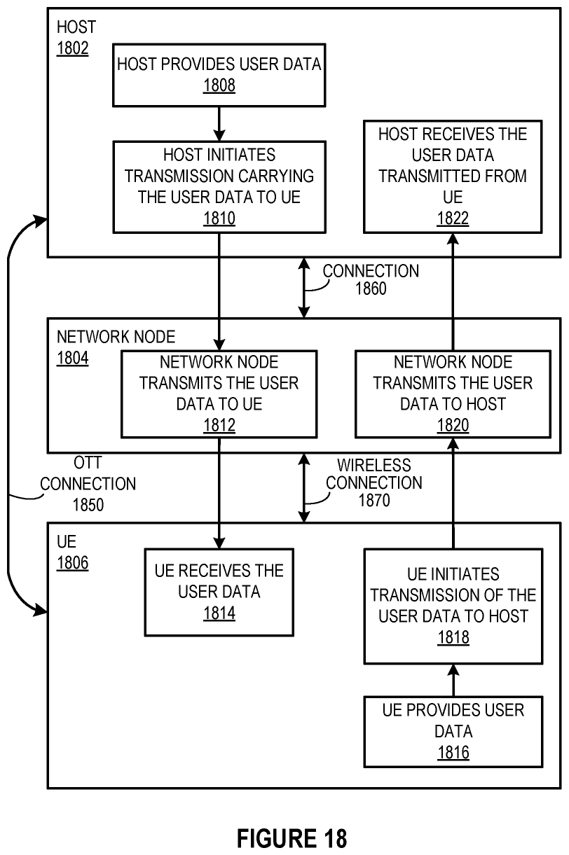

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve the resource configuration and/or power consumption and thereby provide benefits such as better resource efficiency and/or extended battery lifetime.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### NUMBERED EMBODIMENTS

1. A method performed by a user equipment, UE, the method comprising:
signaling (500), towards a network node, a capability information of the UE related to a radio frequency, RF, retuning time.
2. The method of Embodiment 1, wherein the RF retuning time comprises a RF retuning time between two adjacent frequency hops for at least one of a downlink reference signal and an uplink reference signal.
3. The method of any one of Embodiments 1 to 2, wherein the UE performs the RF retuning based on at least one of the following (i) an RF retuning time for at least one of a downlink reference signal reception hop and an uplink reference signal transmission hop from a center frequency to a new center frequency, (ii) a configured downlink reference signal density, (iii) an offset to orthogonal frequency division multiplexing, OFDM, symbols of a downlink reference signal resource, and (iv) a RF retuning time gap configured by the network node.
4. The method of any one of Embodiments 1 to 3, wherein the capability information is used for at least one of (i) a time-frequency resource configuration for a downlink reference signal transmission from the network node to the UE and (ii) a time-frequency resource configuration for an uplink reference signal transmission from the UE to the network node.
5. The method of any one of Embodiments 1 to 4, wherein the network node uses the capability information for a time-frequency resource configuration for downlink reference signal transmission to the UE, and/or the capability information is used for a time-frequency resource configuration for an uplink reference signal transmission from the UE to the network node.
6. The method of any one of Embodiments 1 to 5, further comprising:
performing (502) the RF retuning in accordance with the capability indication.
7. The method of any one of Embodiments 1 to 6, further comprising:
receiving (600) a downlink reference signal resource configuration from the network node for downlink reference signal measurement comprising at least one of wideband downlink reference signal frequency hopping and narrowband downlink reference signal frequency hopping; and
performing (602) at least one of a measurement based on (i) partial downlink reference signal hops based on the RF retuning capability of the UE and (ii) all downlink reference signal hops based on the RF retuning capability of the UE.
8. The method of any one of Embodiments 1 to 6, further comprising:
receiving (700) a resource configuration from the network node comprising a plurality of downlink reference signal frequency hopping patterns; and
performing (702) a measurement based on one of the plurality downlink reference signal frequency hopping patterns; and
signaling (704), towards the network node, the measurement with an identifier of the one downlink reference signal frequency hopping pattern used for the measurement.
9. The method of any one of Embodiments 1 to 8, wherein the RF retuning time comprises a value of a minimum RF retuning time comprising at least one of 0 μs, 30 μs, 50 μs, 60 μs, 100 μs, 110 μs, and 120 μs.
10. The method of any one of Embodiments 3 to 9, wherein the RF retuning time gap is based on a maximum reported RF tuning time from one or more UEs.
11. The method of any one of Embodiments 1 to 10, wherein the UE uses a symbol location for the RF retuning based on a downlink reference signal configuration.
12. The method of any one of Embodiments 3 to 11, wherein the offset to OFDM symbols of the downlink reference signal resource comprises at least one of (i) symbols of a first slot before a first configured OFDM symbol of the downlink reference signal resource, and (ii) OFDM symbols after a last configured OFDM symbol of the downlink reference signal resource.
13. The method of any one of Embodiments 1 to 12, wherein the network node comprises a location server.
14. The method of Embodiment 13, wherein the RF retuning time comprises a RF retuning time between two adjacent frequency hops for downlink reference signal reception, and the signaling the capability information is responsive to a request from the location server.
15. The method of any one of Embodiments 13 to 14, wherein the location server sends the capability information to a base station to use for a downlink reference signal transmission.
16. The method of Embodiment 13, wherein the RF retuning time comprises a RF retuning time between two adjacent frequency hops is for uplink reference signal transmission, and the signaling the capability information is responsive to a request from the location server.
17. The method of Embodiment 16, wherein the location server sends the capability information to a base station to configure uplink reference signal resources in time and frequency domain for the UE.
18. The method of any one of Embodiments 1 to 12, wherein the network node comprises a base station.
19. The method of Embodiment 18, wherein the RF retuning time comprises a RF retuning time between two adjacent frequency hops for downlink reference signal, reception to the base station, and the signaling the capability information is responsive to a request from the base station.
20. The method of Embodiment 19, wherein the base station uses the capability information to configure downlink reference signal resources in time and frequency domain for a downlink reference signal transmission from the base station.
21. The method of Embodiment 18, wherein the RF retuning time comprises a RF retuning time between two adjacent frequency hops for uplink reference signal transmission to the base station, and the signaling the capability information is responsive to a request from the base station.
22. The method of Embodiment 21, wherein the base station uses the capability information to configure uplink reference signal resources in time and frequency domain for the UE.
23. The method of any one of Embodiments 1 to 22, wherein the network node uses the capability information to set the RF retuning time between two adjacent frequency hops for downlink reference signal, reception at the UE side when configuring a time-frequency resource for a downlink reference signal transmission.
24. The method of any one of Embodiments 1 to 23, wherein the network node uses the capability information to set the RF retuning time between two adjacent frequency hops for uplink reference signal transmission at the UE side when configuring a time-frequency resource for an uplink reference signal transmission.
25. The method of any one of Embodiments 1 to 24, wherein the network node configures a frequency hopping pattern to the UE based on the capability information for at least one of intra-slot frequency hopping and inter-slot frequency hopping.
26. The method of any one of Embodiments 1 to 25, wherein the network node configures a plurality of frequency hopping patterns to the UE based on the capability information for at least one of intra-slot frequency hopping and inter-slot frequency hopping.
27. The method of Embodiment 26, further comprising:
receiving (800) an indication from the network node to perform frequency hopping to receive a downlink reference signal transmission, and to perform and to report positioning measurements;
selecting (802) a frequency hopping pattern;
performing (804) the positioning measurements; and
reporting (806) the positioning measurements with an identifier of the selected frequency hopping pattern.
28. The method of any one of Embodiments 1 to 27, wherein the capability information of the UE related to a RF retuning time includes capability information based on a reduced signaling capability of the UE.
29. The method of any one of Embodiments 2 to 28, wherein the downlink reference signal comprises a positioning reference signal, PRS, and the uplink reference signal comprises a sounding reference signal, SRS.
30. A method performed by a network node, the method comprising:
receiving (900) a capability information of a user equipment, UE, related to a radio frequency, RF, retuning time.
31. The method of Embodiment 30, wherein the RF retuning time comprises a RF retuning time between two adjacent frequency hops for at least one of a downlink reference signal and an uplink reference signal.
32. The method of any one of Embodiments 30 to 31, wherein the UE performs the RF retuning based on at least one of the following (i) an RF retuning time for at least one of a downlink reference signal reception hop and an uplink reference signal transmission hop from a center frequency to a new center frequency, (ii) a configured downlink reference signal density, (iii) an offset to orthogonal frequency division multiplexing, OFDM, symbols of a downlink reference signal resource, and (iv) a RF retuning time gap configured by the network node.
33. The method of any one of Embodiments 30 to 32, wherein the capability information is used for at least one of (i) a time-frequency resource configuration for a downlink reference signal transmission from the network node to the UE and (ii) a time-frequency resource configuration for an uplink reference signal transmission from the UE to the network node.
34. The method of any one of Embodiments 30 to 32, wherein the network node uses the capability information for a time-frequency resource configuration for downlink reference signal transmission to the UE, and/or the capability information is used for a time-frequency resource configuration for an uplink reference signal transmission from the UE to the network node.
35. The method of any one of Embodiments 30 to 34, further comprising: signaling (1000) a downlink reference signal resource configuration for downlink reference signal measurement comprising at least one of wideband downlink reference signal frequency hopping and narrowband downlink reference signal frequency hopping.
36. The method of any one of Embodiments 30 to 35, further comprising: signalling (1100) a resource configuration to the UE comprising a plurality of downlink reference signal frequency hopping patterns; and
receiving (1102) (i) measurements based on one of the plurality of downlink reference signal frequency hopping patterns and (ii) an identifier of the one downlink reference signal frequency hopping pattern used for the measurement.
37. The method of any one of Embodiments 30 to 36, wherein the RF retuning time comprises a value of a minimum RF retuning time comprising at least one of 0 μs, 30 μs, 50 μs, 60 μs, 100 μs, 110 μs, and 120 μs.
38. The method of any one of Embodiments 32 to 37, wherein the RF retuning time gap is based on a maximum reported RF tuning time from one or more UEs.
39. The method of any one of Embodiments 30 to 38, wherein the UE uses a symbol location for the RF retuning based on a downlink reference signal configuration.
40. The method of any one of Embodiments 32 to 39, wherein the offset to OFDM symbols of the downlink reference signal resource comprises at least one of (i) symbols of a first slot before a first configured OFDM symbol of the downlink reference signal resource, and (ii) OFDM symbols after a last configured OFDM symbol of the downlink reference signal resource.
41. The method of any one of Embodiments 30 to 40, wherein the network node comprises a location server.
42. The method of Embodiment 41, wherein the RF retuning time comprises a RF retuning time between two adjacent frequency hops is for downlink reference signal reception, and the signaling the capability information is responsive to a request from the location server.
43. The method of Embodiment 42, wherein the location server sends the capability information to a base station to use for a downlink reference signal transmission.
44. The method of Embodiment 41, wherein the RF retuning time comprises a RF retuning time between two adjacent frequency hops is for uplink reference signal transmission, and the signaling the capability information is responsive to a request from the location server.
45. The method of Embodiment 44, wherein the location server sends the capability information to a base station to configure uplink reference signal resources in time and frequency domain for the UE.
46. The method of any one of Embodiments 30 to 40, wherein the network node comprises a base station.
47. The method of Embodiment 46, wherein the RF retuning time comprises a RF retuning time between two adjacent frequency hops is for downlink reference signal reception to the base station, and the signaling the capability information is responsive to a request from the base station.
48. The method of Embodiment 47, wherein the base station uses the capability information to configure downlink reference signal resources in time and frequency domain for a downlink reference signal transmission from the base station.
49. The method of Embodiment 46, wherein the RF retuning time comprises a RF retuning time between two adjacent frequency hops is for uplink reference signal transmission to the base station, and the signaling the capability information is responsive to a request from the base station.
50. The method of Embodiment 49, wherein the base station uses the capability information to configure uplink reference signal resources in time and frequency domain for the UE.
51. The method of any one of Embodiments 30 to 50, wherein the network node uses the capability information to set the RF retuning time between two adjacent frequency hops for downlink reference signal reception at the UE side when configuring a time-frequency resource for a downlink reference signal transmission.
52. The method of any one of Embodiments 30 to 51, wherein the network node uses the capability information to set the RF retuning time between two adjacent frequency hops for uplink reference signal transmission at the UE side when configuring a time-frequency resource for an uplink reference signal transmission.
53. The method of any one of Embodiments 30 to 52, wherein the network node configures a frequency hopping pattern to the UE based on the capability information for at least one of intra-slot frequency hopping and inter-slot frequency hopping.
54. The method of any one of Embodiments 30 to 53, wherein the network node configures a plurality of frequency hopping patterns to the UE based on the capability information for at least one of intra-slot frequency hopping and inter-slot frequency hopping.
55. The method of Embodiment 54, further comprising:
signaling (1200) an indication to the UE to perform frequency hopping to receive a downlink reference signal transmission, and perform and report positioning measurements; and
receiving (1202) a report from the UE comprising the positioning measurements with an identifier of the selected frequency hopping pattern.
56. The method of any one of Embodiments 30 to 55, wherein the capability information of the UE related to a RF retuning time comprises capability information based on a reduced signaling capability of the UE.
57. The method of any one of Embodiments 31 to 56, wherein the downlink reference signal comprises a positioning reference signal, PRS, and the uplink reference signal comprises a sounding reference signal, SRS.
58. A user equipment, UE, (1312, 1400) comprising:
processing circuitry (1402);
at least one memory (1410) connected to the processing circuitry (1402) and storing program code that is executed by the processing circuitry to perform operations comprising: signal, towards a network node, a capability information of the UE related to a radio frequency, RF, retuning time.
59. The UE of Embodiment 58, wherein the at least one memory (1410) is connected to the processing circuitry (1402) and stores program code that is executed by the processing circuitry to perform operations according to any one of Embodiments 2 to 29.
60. A non-transitory computer readable medium (1410) including program code to be executed by processing circuitry (1402) of a user equipment, UE, (1312. 1400), whereby execution of the program code causes the program code to perform operations comprising: signal, towards a network node, a capability information of the UE related to a radio frequency, RF, retuning time.
61. The non-transitory computer readable medium of Embodiment 60, the operations further comprising any of the operations of Embodiments 2 to 29.
62. A network node (1310, 1500) comprising:
processing circuitry (1502);
at least one memory (1504) connected to the processing circuitry (1502) and storing program code that is executed by the processing circuitry to perform operations comprising: receive a capability information of a user equipment, UE, related to a radio frequency, RF, retuning time.
63. The network node of Embodiment 62, wherein the at least one memory (1504) is connected to the processing circuitry (1502) and stores program code that is executed by the processing circuitry to perform operations according to any one of Embodiments 31 to 57.
64. A non-transitory computer readable medium (1504) including program code to be executed by processing circuitry (1502) of a network node (1310, 1500), whereby execution of the program code causes the program code to perform operations comprising:
receive a capability information of a user equipment, UE, related to a radio frequency, RF, retuning time.
65. The non-transitory computer readable medium of Embodiment 63, the operations further comprising any of the operations of Embodiments 31 to 57.

1. A method performed by a user equipment, UE, the method comprising:
signaling, towards a network node, capability information indicating a radio frequency, RF, retuning time of the UE,
receiving a configuration of a downlink reference signal, wherein the configuration comprises a frequency hopping configuration of the downlink reference signal, and
performing RF retuning for measurement of the downlink reference signal in accordance with the indicated capability, wherein the performing RF retuning for measurement of the downlink reference signal comprises performing RF retuning based on partial downlink reference signal hops.

2-4. (canceled)

5. The method of claim 1, wherein signaling the capability information is responsive to a request from the network node.

6. The method of claim 5, wherein the request is a request for downlink time difference of arrival, DL-TDOA, capability or a request for multi-round trip time, RTT, capability.

7. The method of claim 1, wherein the network node comprises a location server or a base station.

8. The method of claim 1, wherein the UE is a reduced capability, RedCap, UE.

9. The method of claim 1, wherein the downlink reference signal comprises a positioning reference signal, PRS.

10. A method performed by a network node, the method comprising:
receiving, from a user equipment, UE, capability information indicating a radio frequency, RF, retuning time of the UE,
signaling, to the UE, a configuration of at least one of a downlink reference signal and an uplink reference signal, wherein the configuration comprises a frequency hopping configuration of the downlink reference signal and/or the uplink reference signal, and
receiving, from the UE, a report for measurements of the downlink reference signal on partial downlink reference signal hops.

11. The method of claim 10, wherein the frequency hopping configuration is in accordance with the indicated capability of the UE.

12. The method of claim 10, further comprising using the indicated capability for configuring the frequency hopping configuration of the downlink reference signal.

13. The method of claim 10, further comprising signaling, to the UE, a request for capability information.

14. (canceled)

15. The method of claim 10, wherein the network node comprises a location server or a base station.

16-18. (canceled)

19. A user equipment, UE, configured to:
signal, towards a network node, capability information indicating a radio frequency, RF, retuning time of the UE,
receive a configuration of a downlink reference signal, wherein the configuration comprises a frequency hopping configuration of the downlink reference signal, and
perform RF retuning for measurement of the downlink reference signal in accordance with the indicated capability, wherein the perform RF retuning for measurement of the downlink reference signal comprises perform RF retuning based on partial downlink reference signal hops.

20. The UE of claim 19, wherein signal the capability information is responsive to a request from the network node.

21. A network node configured to:
receive, from a user equipment, UE, capability information indicating a radio frequency, RF, retuning time of the UE, and
signal, to the UE, a configuration of at least one of a downlink reference signal and an uplink reference signal, wherein the configuration comprises a frequency hopping configuration of the downlink reference signal and/or the uplink reference signal, and
receive, from the UE, a report for measurements of the downlink reference signal on partial downlink reference signal hops.

22. The network node of claim 21, wherein the frequency hopping configuration is in accordance with the indicated capability of the UE.
